(19) United States
(12) Patent Application Publication
(10) Pub. No.: US 2006/0264170 A1
(43) Pub. Date: Nov. 23, 2006

(54) Broadcast receiver apparatus

(75) Inventor: Tadashi Ono, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/434,413

(22) Filed: May 15, 2006

(30) Foreign Application Priority Data
May 20, 2005 (JP) JP2005-148385
Mar. 22, 2006 (JP) JP2006-079230

(51) Int. Cl. H04H 1/00

(52) U.S. Cl. 455/3.01

(57) ABSTRACT

The broadcast receiver apparatus is capable of receiving a broadcast signal and operating with power fed from at least a battery, and the broadcast receiver apparatus includes a tuner for tuning a broadcast wave, a tuning controller capable of a while station search of controlling the tuner and scanning sequentially all of the channels allocated to the television broadcast so as to search for a receivable channel, and a power remaining amount detector for detecting a power remaining amount of a battery, and the broadcast receiver apparatus suppresses the whole station search in accordance with the power remaining amount detected by the power remaining amount detector. As a result, even when a channel selection operation not intended by a user is input, wasteful power consumption is prevented and duration of the viewing can be extended.

### BACKGROUND OF THE INVENTION

1. Field of the Invention

The present invention relates to a broadcast receiver apparatus such as a television receiver that can receive a television signal. Specifically, the present invention relates to a broadcast receiver apparatus that can be driven by a portable power source.

2. Description of Related Art

Digital television broadcast as a kind of television broadcast was first started as the satellite digital television broadcast on December 2000, and became full-scale with the start of the terrestrial digital television broadcast on December 2003. The digital television broadcast is characteristic since it serves to improve the quality of video and audio, it can correspond to multi-channeling and it provides character data such as data broadcasting. Moreover, according to the terrestrial digital television broadcast, it is possible to send in parallel in one channel a high-quality image for a fixed television receiver and a simple image for a portable television receiver. Demand for television viewing through the portable television receivers is expected to increase further.

For the digital television broadcast in Japan, ARIB (Association of Radio Industries and Businesses) provides the standards. ARIB summarizes the application rules based on the standards in the form of Technical Report. The application rules for the terrestrial digital television broadcast are described in “ARIB TR-B14”.

FIG. 6 is a block diagram showing a typical digital television broadcast reception terminal according to the disclosure of D1 (JP 2002-359791 A).

As shown in FIG. 6, with respect to a digital television broadcast wave received via an antenna 501, a tuner 502 extracts a broadcast wave corresponding to a channel assigned by a tuning controller 503 and decodes it to acquire a transport stream. A stream separator 504 separates at least a video stream and an audio stream from the transport stream thus acquired by the tuner 502 (though a stream of a data broadcast or the like may be multiplexed as well in the case of a digital broadcast, the explanation is omitted here).

A video decoder 505 decodes the video stream that has been separated at the stream separator 504 so as to acquire video data, and feeds the video data to a video output part 506 (a monitor or the like). As a result, the video data are output via the video output part 506.

Similarly, an audio decoder 507 decodes the audio stream that has been separated at the stream separator 504 so as to acquire audio data and feeds the audio data to an audio output part 508 (a speaker or the like). As a result, the audio data are output via the audio output part 508.

When there is a request from the exterior (a user) for tuning to another channel, the tuning controller 503 resets at least the stream separator 504 and interrupts the viewing. Later, the tuning controller 503 acquires a transport stream with respect to the requested channel from the tuner 502 and feeds the transport stream to the stream separator 504. In this manner, the channel can be viewed after the tuning.

FIG. 7 is a list indicating a correspondence between viewable channels and broadcasting stations. Such a list is called a channel list. A transport stream of a digital television broadcast is multiplexed in predetermined carrier frequencies from the respective broadcasting stations and sent. Predetermined channels (physical channels) are allocated to the frequencies of the respective carrier waves, and a bandwidth of a frequency for one channel is about 6 MHz. As of April 2005, the terrestrial digital television broadcast on air uses a UHF band of physical channels ranging from the channel number “13” to the channel number “30”. It is noted that after termination of the analog waves in the year of 2011, there is a possibility that the digital television channels expand (including the VHF band). In some countries other than Japan, channels have been allocated under the inherent standards of the respective countries.

A remote control number denotes a number allocated separately from the physical number for the purpose of realizing an easy tuning of digital television broadcast, with a button structure similar to that of a remote controller used for the conventional analog television broadcast. The remote control number is allocated in order to provide compatibility as much as possible with a so-called “channel” that has been used long in the analog television broadcast. In this context, the term “channel” indicates a physical channel, not the remote control number.

In the terrestrial digital television broadcast, similar to the conventional analog television broadcast, the respective broadcasting stations provide services in principle for the respective prefectures or areas (for metropolitan or large city areas, several adjacent prefectures are regarded as one prefectural area). Therefore, the channel list will be defined also in principle for each prefecture. As a result, when the location (prefectural area) of the television receiver is changed, the former channel list will be unavailable, and thus a search for viewable channels (channel search) must be conducted afresh. The channel search is classified into a whole station search and a next station search.

The whole station search indicates a process of scanning sequentially all of the physical channels allocated to the terrestrial digital television broadcast, listing receivable channels, and forming a channel list corresponding to the present address (location of the television receiver). That is, in the example as shown in FIG. 7, all of the physical channel numbers “13-30” are scanned sequentially so as to decide whether reception of the broadcast wave is possible, and in a case where reception is possible, the broadcast station name and the remote control number are allocated. For the information of the broadcasting station name, the information of broadcasting station name included in the multiplexed information can be used. Alternatively, the broadcasting station name can be stored previously in the television receiver.

On the other hand, the next station search denotes a process of searching physical channels in an ascending/descending order with respect to the currently selected physical channel, tuning a viewable channel at the stage where a viewable channel is found, and ending the process. When issuing an instruction of a descending next station search while viewing the G station (physical channel number: “24”) for example in an area having the channel list as shown in FIG. 7, the tuner 402 tries to receive the channel number “23”. Since no broadcasting station is allocated to the channel number “23” in the channel list of this figure, reception of the broadcast wave ends in failure. Subsequently, the tuner 402 tries to receive the channel number “22”. The operation is repeated in this manner, and when a channel that can receive the broadcast wave is tuned, the next station search is ended. Since the broadcast wave of the F station can be received when trying to receive the channel number “18” in the channel list of FIG. 7, this channel is selected for viewing, and the operation of the next station search is ended.

In FIG. 7, the channel number “13” and the channel number “30” are regarded as being adjacent to each other.

According to the above description, when no broadcasting station is allocated to a certain channel, reception of the channel will end in failure. Even for a channel to which a broadcasting station is allocated, reception may end in failure sometimes. For example, when the broadcast is stopped or when the tuning is conducted behind a building or the like where the reception is weakened, reception of channels that should be viewable inherently may end in failure.

In such a case, the channel search is continued in a descending order. Moreover, the next station search can be based on not only the physical channel but the remote control number.

Such a channel search function is essential for a portable television receiver that can be hand-carried throughout various areas, and preferably the operation is simple and easy.

Moreover, since the portable television receiver often uses a battery rather than the 100 V commercial power, it should be driven by a small, lightweight and high-voltage battery. Primary batteries such as dry cells can be used as well as a rechargeable battery as long as these requirements are satisfied. For recharging the battery, natural energy such as sunshine can be used as well as the 100 V commercial power.

However, the portable television receiver mentioned above has the following problems.

During the channel search, the tuner 502 performs setting of a predetermined channel, wave detection, and determination of viewability, and in addition, in a case where viewing is available, it performs for example, acquisition of the channel information (including program information such as EPG: Electronic Program Guide) multiplexed in the broadcast wave and renewal to a memory. Therefore, it consumes more power in comparison with a case of steadily viewing a fixed channel. Particularly, the number of the channels is expected to increase in the future, which may increase the power consumption further.

In addition, during the channel search, broadcast of any channel cannot be viewed. Although viewing during the channel search would be available by providing plural antennas and tuners, the cost would be raised.

As mentioned above, the operation for conducting the channel search is preferred to be simple and easy for the portable television receiver. As a result, however, a risk that the user conducts the channel search by error would increase considerably. When the user conducts an unintended channel search while viewing the television program, the tuner 502 will be used for the channel search. As a result, the user cannot view the program any more, and in addition, power will be consumed wastefully, eventually shortening the viewable time period based on the power remaining amount of the battery (hereinafter, referred to as ‘battery remaining amount’).

Even when the unintentionally performed channel search is interrupted, the tuning must be conducted again for viewing the former channel, and thus the power will be consumed wastefully anyway.

The malfunction as mentioned above can cause more serious problem when the battery remaining amount is insufficient. That is, when the battery remaining amount is sufficient, there remains sufficient time for the user to go home for example so that the battery is brought into a rechargeable condition, and thus the user can continue viewing the television program. However, when the battery remaining amount is insufficient, there is an extremely high risk that the viewing cannot be continued since the battery remaining amount turns to zero by the time the battery is brought into a rechargeable condition. Since a typical television broadcast is a medium that is extremely difficult for the user to trace back and view the contents the user have missed, ensuring of continuity in viewing is important.

D1 discloses a technique for limiting operations in renewing program information such as EPG performed at the time of tuning when the power is fed from a battery to a digital broadcast receiver apparatus that can be driven by both a commercial power source and a battery. According to the technique, however, when the power is fed from the battery, the tuning operation will be limited even if the battery remaining amount is sufficient. This will cause a problem of degradation in workability for a portable television receiver that is driven often by a battery.

### SUMMARY OF THE INVENTION

Therefore, with the foregoing in mind, it is an object of the present invention to prevent a wasteful power consumption and extend the duration of the viewing even when a channel selection operation not intended by the user is input.

For achieving the above mentioned object, a broadcast receiver apparatus according to the present invention is a broadcast receiver apparatus that can receive a broadcast signal and that can operate with power fed by at least a battery, and the broadcast receiver apparatus includes a channel searcher that can search for viewable channels, a tuner for tuning a broadcast wave corresponding to the channel searched by the channel searcher, and a power remaining amount detector for detecting the power remaining amount of the battery. The broadcast receiver apparatus suppresses the searching operation depending on the power remaining amount detected by the power remaining amount detector.

### BRIEF DESCRIPTION OF THE DRAWINGS

FIG. 1 is a block diagram showing a configuration of a broadcast receiver apparatus in Embodiment 1 of the present invention.

FIG. 2 is a flow chart for explaining operations of the tuning controller at the time of a whole station search in Embodiment 1.

FIG. 3 is a block diagram showing a configuration of a broadcast receiver apparatus in Embodiment 2 of the present invention.

FIG. 4 is a flow chart for explaining operations of the tuning controller at the time of a whole station search in Embodiment 2.

FIG. 5A is a schematic view specifying an example of the broadcast receiver apparatus in Embodiment 2.

FIG. 5B is a schematic view specifying another example of the broadcast receiver apparatus in Embodiment 2.

FIG. 6 is a block diagram showing a configuration of a conventional broadcast receiver apparatus.

FIG. 7 shows an example of a channel list.

### DETAILED DESCRIPTION OF THE INVENTION

In the broadcast receiver apparatus of the present invention, the channel searcher can be capable of a whole station search of controlling the tuner and scanning sequentially all of the channels allocated to the broadcast so as to search for a receivable channel, where the whole station search can be suppressed when the power remaining amount detected by the power remaining amount detector is less than a first predetermined power remaining amount value.

The channel searcher is capable also of a next station search of searching for a receivable adjacent channel with respect to a channel currently selected by the tuner, where the next station search can be suppressed when the power remaining amount detected by the power remaining amount detector is less than a second predetermined power remaining amount value.

Furthermore, an operator is provided as well, and the operator is capable of selecting and inputting whether or not to perform a channel selection operation at the channel searcher. When the power remaining amount detected by the power remaining amount detector is less than a predetermined power remaining amount and there is an input of selection not to perform the channel selection operation by the operator, the searching operation can be suppressed.

In this configuration, the channel searcher is capable of a whole station search of controlling the tuner and scanning sequentially all of the channels allocated to the broadcast so as to search for a receivable channel, where the whole station search can be suppressed when the power remaining amount detected by the power remaining amount detector is less than a first predetermined power remaining amount value and when there is an input of selection not to perform the channel selection operation by the operator.

The channel searcher is capable of a next station search of searching a receivable adjacent channel with respect to a channel currently selected by the tuner, where the next station search can be suppressed when the power remaining amount detected by the power remaining amount detector is less than a second predetermined power remaining amount value and when there is an input of selection not to perform the channel selection operation by the operator.

According to the present invention, a searching operation is suppressed when the power remaining amount of the battery is insufficient, and thus a wasteful power consumption can be suppressed so that reduction of duration of the viewing can be prevented.

Moreover, in a case where the battery remaining amount is sufficient or in a case of feeding power from a commercial power source, the tuning operation is not limited, and thus the workability will not deteriorate.

### Embodiment 1

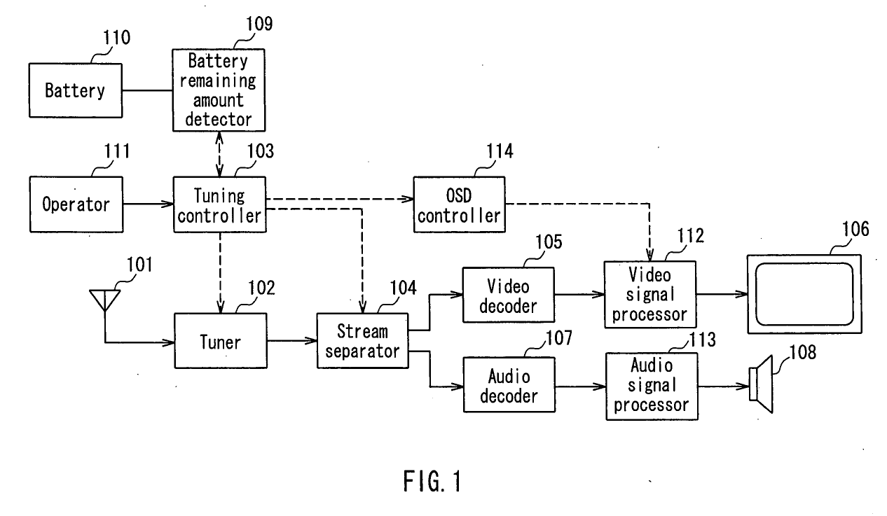

FIG. 1 is a block diagram of a digital television broadcast receiver according to Embodiment 1. The description in this embodiment referring to a digital television broadcast receiver as an example of a broadcast receiver apparatus is not an only example, but the embodiment can be applied, for example, to an analog television broadcast receiver and an apparatus that can receive a radio broadcast.

In FIG. 1, an antenna 101 can receive a broadcast wave. Since the digital television receiver apparatus in this embodiment is an apparatus capable of receiving a terrestrial digital broadcast, it can receive a broadcast wave of a terrestrial digital broadcast through the antenna 101. The broadcast wave of the terrestrial digital broadcast is sent as a transport stream that is a combination of thirteen blocks (segments) for example, having a predetermined bandwidth for each channel.

A tuner 102 tunes a desired channel from the broadcast wave received by the antenna 101 and acquires it as a transport stream. A tuning operation is performed under the control by a tuning controller 103. This tuner 102 corresponds to a so-called tuner and a demodulator. In this embodiment, it corresponds to a terrestrial digital tuner.

An operator 111 enables the user to conduct various operations of the apparatus. According to this embodiment, at least operations such as channel tuning and channel search instruction can be conducted. Examples of this operator 111 include a channel button provided on a television receiver or a channel button provided on a remote controller (not shown) for a television receiver.

The tuning controller 103 (channel searcher) performs a tune-control (channel selection operation) with respect to the tuner 102 in accordance with the tuning instruction that has been operate-input by the operator 111. The tuning controller 103 performs, in addition to the tuning control, a control of channel search such as a whole station search and a next station search, a reset control with respect to a stream separator 104, and a battery remaining amount detection control with respect to a battery remaining amount detector 109. Operations of the respective controls will be described later.

The stream separator 104 separates a transport stream that has been tuned and acquired at the tuner 102 into at least a video stream and an audio stream. In addition to these streams, a stream of a data broadcast or the like may be multiplexed in addition to these streams, though the details are omitted here.

A video decoder 105 decodes the video stream, which has been separated by the stream separator 104, into a video signal. The thus decoded video signal is an analog video signal, for example.

A video signal processor 112 processes the video signal, which has been decoded by the video decoder 105, into a video signal that can be displayed by a video output part 106. The signal process includes a signal level adjustment, an image size adjustment, an image quality adjustment and the like, but the processes are not limited particularly. The video signal processor 112 is not an essential component.

The video output part 106 is capable of outputting the video signal from the video signal processor 112, and in this embodiment it is configured as a display that can display and output a video signal. An example of the display can be a liquid crystal monitor, but any other displays can be used as well. Though the video output part 106 in this embodiment is illustrated as a display, alternatively it can be configured as an output terminal that can output a video signal to the exterior. External equipment that can be connected to the output terminal is a display apparatus such as a monitor, for example.

An audio decoder 107 decodes the audio stream, which has been separated at the stream separator 104, into an audio signal. The thus decoded audio signal is an analog audio signal, for example.

An audio signal processor 113 processes the audio signal, which has been decoded at the audio decoder 107, into an audio signal that can be output as an audio by an audio output part 108. Examples of the signal process include noise rejection and signal level adjustment, but the processes are not limited particularly. The audio signal processor 113 is not an essential component.

The audio output part 108 can output the audio signal as an audio from the audio signal processor 113, and it corresponds to an audio output part such as a speaker, for example. Though the audio output part 108 in this embodiment is illustrated as an audio output part, alternatively it can be configured as an output terminal. An example of external equipment that can be connected to the output terminal is an amplifier.

A battery 110 to feed electric power to this apparatus can be either a dry cell or a battery charger. In this embodiment, a battery charger is used since it is small, lightweight and high-powered. Though this embodiment refers to a configuration to be operated with power fed from the battery 110, a commercial power source can be used in addition to the battery 110. A primary cell such as a dry cell can be used as well as the battery charger. The battery can be recharged by using a 100V commercial power, or alternatively by using natural energy such as sunshine. The battery 110 can be a fuel cell.

A battery remaining amount detector 109 detects the power remaining amount of the battery 110. The battery remaining amount can be detected by measuring the power source voltage at the battery 110, for example. The remaining amount detecting operation at the battery 110 can be performed according to the instruction from the tuning controller 103, or the remaining amount detecting operation can be performed constantly irrespective of instructions from the tuning controller 103. When the battery 110 is configured as a fuel cell, the battery remaining amount is detected on the basis of the remaining amount of the fuel in the fuel cell.

An OSD controller 114 allows the video output part 106 to display a message under a control from the tuning controller 103. In this embodiment, the video signal is overlapped with a separately-generated character signal (on-screen-display signal, hereinafter referred to as “OSD signal”), but the present invention will not be limited to this example.

Operations of an apparatus having the above-mentioned configuration according to this embodiment will be described below.

When a user operates the operator 111 to tune a desired channel, a tuning instruction from the operator 111 is input into the tuning controller 103. In accordance with the tuning instruction, the tuning controller 103 controls the tuner 102 so that the tuner 102 tunes a channel as instructed by the user.

On the other hand, a broadcast wave of a terrestrial digital broadcast received through the antenna 101 is fed to the tuner 102. The tuner 102 extracts a broadcast wave with respect to a channel that has been instructed by the tuning controller 103 and decodes it, thereby acquiring a broadcast stream of the channel (hereinafter, referred to as a transport stream).

The transport stream acquired at the tuner 102 is fed to the stream separator 104. At the stream separator 104, at least a video stream and an audio stream multiplexed in the transport stream are separated (a data broadcast stream, a caption stream or the like may be multiplexed in the transport stream, though the explanation is omitted here).

The video stream is fed to the video decoder 105 and decoded into a video signal, and then input into the video signal processor 112. At the video signal processor 112, the signal is processed into a video signal that can be displayed by the video output part 106. The signal process is a signal level adjustment, an image quality adjustment, a video size adjustment and the like. A video signal from the video signal processor 112 is input into the video input part 106 and displayed on a display such as a liquid crystal display.

Similarly, the audio stream is fed to the audio decoder 107 and decoded into an audio signal, and then input into an audio signal processor 113. At the audio signal processor 113, the signal is processed into an audio signal that can be output as an audio by the audio output part 108. The audio signal output from the audio signal processor 113 is input into the audio output part 108 and output as an audio by an audio output part such as a speaker.

In this embodiment, since the video output part 106 is configured as a display such as a liquid crystal monitor and the audio output part 108 is configured as a speaker, the video signal of the received broadcast program is displayed on the display, and the audio signal is output from the speaker. According to this configuration, the video and the audio can be viewed and listened.

The apparatus is driven with power fed from a commercial power source such as a domestic 100V power source or a battery formed of a dry cell or a battery charger. Operations of the apparatus being fed with power from a battery will be described below.

The respective components of the apparatus operate with power fed from the electrically-connected battery 110. The power remaining amount of the battery 110 is detected by the battery remaining amount detector 109 in accordance with the instruction from the tuning controller 103. In this embodiment, the battery remaining amount detector 109 is configured to perform the detection of the remaining amount of the battery 110 in accordance with the instruction from the tuning controller 103. Alternatively, it can be configured to perform the detection of remaining amount constantly (continuously or intermittently) irrespective of the instruction from the tuning controller 103. When this apparatus is connected to a commercial power source, it is possible to detect the power value by the battery remaining amount detector 109. At that time, the power remaining amount detected by the battery remaining amount detector 109 is regarded as a sufficiently large value or infinite. When this apparatus is connected to a commercial power source, a whole station search can be conducted irrespective of the remaining amount of the battery 110.

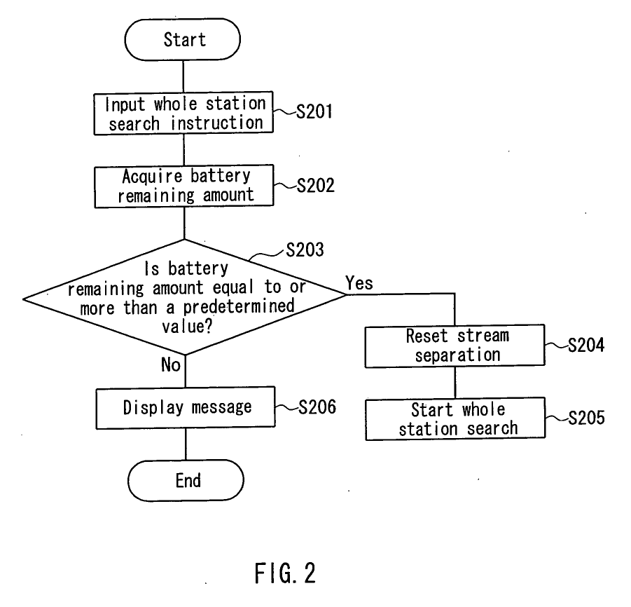

Next, operations for a whole station search will be described with reference to the flow chart in FIG. 2. Explanations for basic operations for search (channel search) such as the whole station search or the next station search will be omitted here in order to avoid duplicate explanation.

When the user operates the operator 111 so as to issue an instruction of the whole station search (step S201), the tuning controller 103 requests to the battery remaining amount detector 109 for battery remaining amount information. The battery remaining amount detector 109 detects the power remaining amount of the battery 110 in accordance with the instruction from the tuning controller 103. The battery remaining amount detector 109 sends the thus detected power remaining amount as the battery remaining amount information to the tuning controller 103, and the tuning controller 103 acquires the information (step S202). The tuning controller 103 compares the power remaining amount value detected by the battery remaining amount detector 109 with a predetermined value (first predetermined power remaining amount value) (step S203), and when the power remaining amount value is equal to or higher than the predetermined value, the battery remaining amount detector 109 instructs the tuner 102 to perform the whole station search. At this time, at least the stream separator 104 is reset (step S204) so as to interrupt temporarily viewing and listening of the video and audio.

Here, the stream data received by the tuner 102 and the video/audio signals decoded by the video decoder 105 and the audio decoder 107 are stored temporarily in a buffer memory (not shown) so as to be subjected to a stream separation process or a decoding process. As a result, the former video and audio (video and audio based on the broadcast signals that have been received before the whole station search) remaining in the buffer memory, or noises may be output after the whole station search is ended. According to this embodiment where the whole station search is performed after resetting the buffer memory in the step S204 for avoiding the problem, output of unnecessary video and audio or noises is prevented. The resetting process is not an essential process.

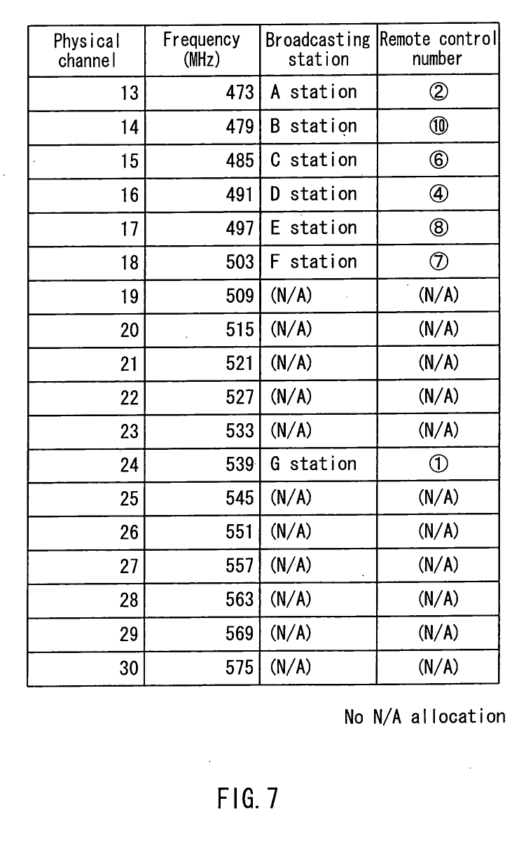

Next, the tuner 102 starts a whole station search operation (step S205). After the whole station search, a channel list (see FIG. 7, for example) generated by the OSD controller 114 can be displayed by the video output part 106. Alternatively, the channel viewed just before the whole station search can be selected again to re-start viewing.

When the power remaining amount value is less than the predetermined value, the tuning controller 103 does not instruct the tuner 102 to perform the whole station search, and thus the tuner 102 does not perform the whole station search. It is possible at this time to create a message to inform the user about the impossibility of the whole station search at the OSD controller 114 due to the insufficient battery remaining amount, and to display the message by the video output part 106 for notification (step S206). The notification by displaying a message in the step S206 is not always limited to a visual display by the vide output part 106, but various methods can be used, for example, a LED is lit up or an audible warning is output from the audio output part 108. Alternatively, the instruction of whole station search input at the operator 111 can be invalidated without displaying any messages.

When the predetermined value (first predetermined power remaining amount value) as a diagnostic criterion in the decision step of step S203 is extremely low, the remaining amount of the power of the battery 110 may turn to zero during the whole station search, and thus even the television broadcast may not be viewed after the whole station search. In order to avoid this situation, it is preferable that the predetermined value is set to be equal to or less than the power required for the whole station search, and it is further preferable that the predetermined value is high enough that the television broadcast can be viewed for a certain time period after the whole station search. For example, the value can be set so that the television broadcast can be viewed for about 30 minutes after the whole station search. That is, when Ws denotes a power required for the whole station search, Wt denotes a power required for viewing a television broadcast for a certain time (e.g., 30 minutes), and Wc denotes a predetermined value (first predetermined power remaining amount value), the value of Wc is set to satisfy Wc≧(Wt+Ws).

In a typical case of a whole station search, at least 2 seconds are necessary according to the standards for determining one channel being not viewable. Therefore, the whole search of 18 channels from the channel 13 to the channel 30 requires about 36 seconds theoretically.

Moreover, the analog television broadcast is expected to terminate completely in the year of 2011. After that, channels from the channel 31 to the channel 62, which have been used for the analog UHF broadcast, may be allocated to the band for the terrestrial digital broadcast. As a result, when the whole search is conducted for the channels from the channel 13 to the channel 62, about 100 seconds will be required only for the viewability decision. In addition to that, the time for a frequency re-setting operation at the time of tuning, and the time for acquisition and renewal of channel information of viewable channels and program information will be required.

It should be noted that the above-mentioned times required for the search process are indicated with theoretical or standard numerical values. Actually in many cases, a search process will be completed in a time shorter than the above-noted times.

During the whole station search, the user cannot view the television broadcast at all. Furthermore, since more power is consumed during the whole station search than during an ordinary viewing, the power remaining amount of the battery will be reduced faster than in a case of a next station search, and consequently the viewable time is reduced.

As mentioned above, a channel search will not be performed when the battery remaining amount is less than a predetermined value in Embodiment 1, thereby preventing excessive viewable time reduction that is caused by a channel search operation not intended by the user.

Though the explanation in this embodiment refers to a whole station search, a next station search can be performed in the similar manner. In a case of the next station search, a predetermined value (second predetermined power remaining amount value) for a decision about feasibility of the next station search can be the same as the whole station search (first predetermined power remaining amount value). Alternatively, it can be set differently. That is, since the next station search requires shorter searching time than the whole station search, the power consumption during the search can be shorter as well in the next station search. Therefore, the next station search can be performed efficiently by setting the predetermined value in step S203 in FIG. 2 to be lower than in the whole station search.

The predetermined value for determining the battery remaining amount can be modified depending on the environmental temperature, the battery type and the like.

The present invention is particularly effective in a digital broadcast receiver, which consumes more power than an analog television broadcast receiver at the time of channel search and switchover.

The components, specifically, the tuning controller 103, the stream separator 104, the video decoder 105, the audio decoder 107, the video signal processor 112, and the audio signal processor 113, can be integrated in a chip by using a semiconductor element such as a microcomputer. Alternatively, any of the respective circuits can be combined arbitrarily into a chip, for example, only the audio decoder 107 and the audio signal processor 113 can be integrated into a chip by using a semiconductor element such as a microcomputer.

### Embodiment 2

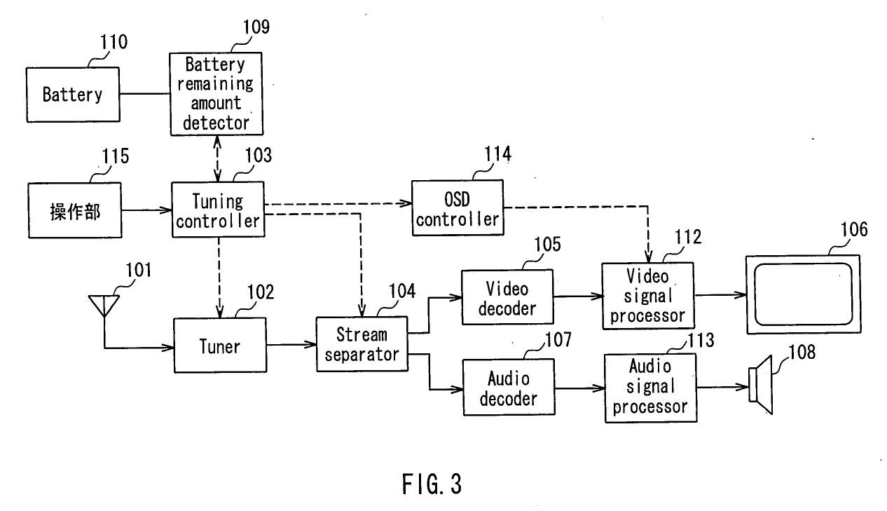

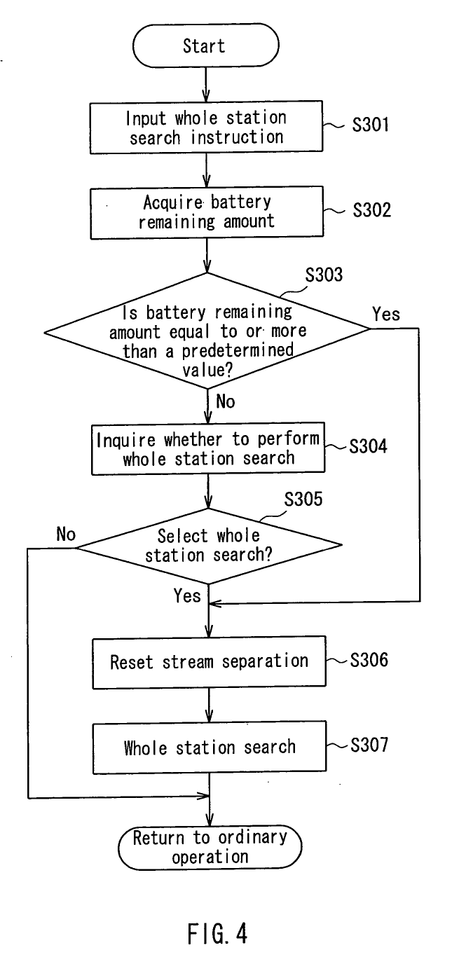

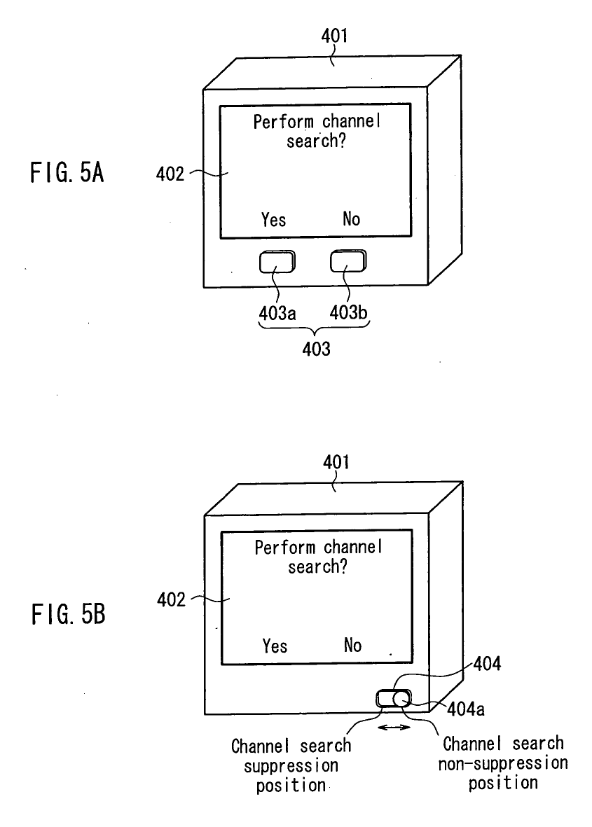

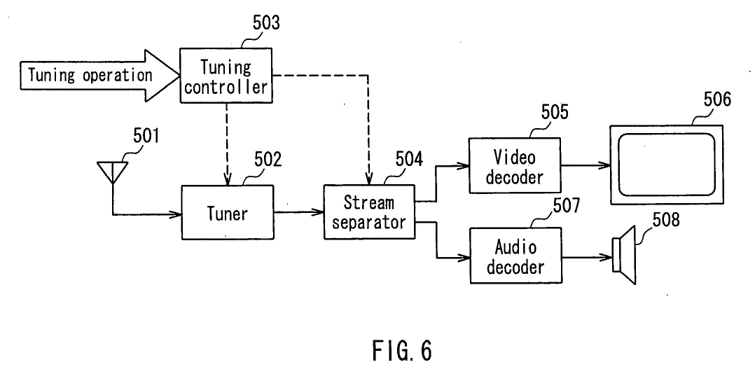

FIG. 3 is a block diagram showing a digital television broadcast receiver in Embodiment 2. FIG. 4 shows a control flow at the time of performing a channel search on the basis of the battery remaining amount. FIGS. 5A and 5B are schematic views showing an appearance of a main frame of a digital television broadcast receiver.

In FIG. 4, the OSD controller 114 allows the video output part 106 to display a message under a control by the tuning controller 103. In this embodiment, as shown in FIGS. 5A and 5B, a separately generated character signal (OSD signal) is overlapped with a video signal on a broadcast wave, though the configuration is not limited to this example.

In FIGS. 5A and 5B, a display 402 for projecting video signals on its main face is arranged in a main frame 401 of the digital television broadcast receiver. The display 402 is configured as a liquid crystal display, for example.

An operation button 403 is included in the operator 115 in FIG. 3. The operation button 403 is arranged on the main frame 401 for the user to operate the respective functions of the apparatus. For an explanation, only two operation buttons, i.e., a first operation button 403a and a second operation button 403b, are shown in FIG. 5A. Various operation buttons other than these buttons are provided as well.

By use of the operation button 403, the user can select whether or not to perform the channel search. In the configuration of FIG. 5A, to the message display of “Perform channel search?”, a response of ‘Yes’ can be input by operating the first operation button 403a and ‘No’ by operating the second operation button 403b. Though the operation button 403 is allocated usually with other functions, it is allocated with input of response of ‘Yes’ and ‘No’ as mentioned above only when the user determines necessity of the channel search as shown in FIG. 5A.

A selection switch 404 is configured as a so-called sliding switch arranged on the main frame 401 and including an operation knob 404a. The operation knob 404a can slide in the direction of the arrows. In this embodiment, it is possible to set a channel search suppression by sliding the operation knob 404a to the left in the figure, and a channel search permission by sliding the operation knob 404a to the right in the figure.

The configuration in this embodiment is not limited necessarily to either the press button as shown in FIG. 5A or the sliding switch as shown in FIG. 5B, but any other systems can be applied as long as the user can select the necessity of the channel search.

In the following explanation on Embodiment 2, the emphasis is placed on differences from the Embodiment 1.

When the user provides an instruction for a whole station search to the tuning controller 103, in a case where the power remaining amount value of the battery is less than a predetermined value, the tuning controller 103 controls the OSD controller 114 so that the OSD controller 114 generates an OSD signal as a video of a predetermined message. Due to the control by the tuning controller 103, the OSD controller 114 generates an OSD signal and outputs it to the video signal processor 112. The video signal processor 112 controls the video output part 106 so as to display the OSD signal from the OSD controller 114, and thus the video output part 106 can display the OSD signal.

Next, the operations of the whole station search will be described by referring to the flow chart of FIG. 4. Since the basic operations of the search (channel search) such as the whole station search and the next station search have been described above, a detailed explanation will be omitted.

When the user operates the operator 115 and issues an instruction of a whole station search (step S301), the tuning controller 103 requests the battery remaining amount detector 109 for battery remaining amount information. The battery remaining amount detector 109 detects the power remaining amount of the battery 110 in accordance with the instruction from the tuning controller 103. The battery remaining amount detector 109 sends the thus detected power remaining amount as the battery remaining amount information to the tuning controller 103, and the tuning controller 103 acquires the information (step S302).

The tuning controller 103 compares the power remaining amount value that has been detected by the battery remaining amount detector 109 with a predetermined value (first predetermined power remaining amount value) (step S303). When the power remaining amount value is equal to or higher than the predetermined value, the tuning controller 103 issues an instruction of a whole station search to the tuner 102a. When the power remaining amount value is less than the predetermined value, the tuning controller 103 allows the video output part 106 to display a message (step S304).

The message displayed on the video output part 106 includes contents to make the user select whether or not to perform a whole station search, as shown in FIGS. 5A and 5B for example. With respect to the display, the user operates the operator 115 so as to select whether or not to perform the whole station search (step S305).

When the user inputs an instruction not to perform the whole station search, the process is ended.

When the user inputs an instruction to perform the whole station search, or when the power remaining amount value is equal to or more than the predetermined value (determination result of step S303), at least the stream separator 104 is reset (step S306) to interrupt temporarily viewing and listening of the video and audio. Since the resetting process at the stream separator 104 has been explained in Embodiment 1, the details will be omitted here.

Next, the tuner 102 starts the whole station searching operation (step S307). After ending of the whole station search, the thus formed channel list (see FIG. 7, for example) can be displayed by the video output part 106. Alternatively, the channel that has been viewed just before the whole station search can be selected again so as to restart the viewing.

An example of message to be displayed by the video output part 106 is shown in FIG. 5A. As shown in FIG. 5A, an OSD signal (the character information “Perform channel search?” “Yes” “No” in the figure) output from the OSD controller 114 is displayed on the display 402. The OSD signal can be displayed alone on a monochromatic video such as a blueback. Alternatively, the OSD signal can be displayed in a state superimposed on the video signal currently viewed.

At this time, the operation button 403 is allocated with a function for enabling response to the message shown in FIG. 5A. Specifically, a function enabling input of ‘Yes’ is allocated to the first operation button 403a, and a function enabling input of ‘No’ is allocated to the second operation button 403b. When the user operates either the first operation button 403a or the second operation button 403b, the operation of the user is notified from the operator 115 to the tuning controller 103. When the user operates the first operation button 403a, the tuning controller 103 controls the tuner 102 so as to perform a whole station search. When the user operates the second operation button 403b, the whole station search will not be performed.

FIG. 5B shows a configuration where the necessity of the channel search can be set by means of a sliding switch. In this configuration, the channel search is suppressed by sliding the operation knob 404a to the left in the figure, and the channel search is permitted by sliding the operation knob 404a to the right. In this configuration, irrespective of the existence of the message display as shown in FIG. 5A, the user can set previously the necessity of the channel search.

As mentioned above, according to Embodiment 2, when the battery remaining amount is insufficient, the user can determine and input whether the user intends to conduct a channel search or not. As a result, the intention of the user will be reflected, and wasteful power consumption due to the channel search can be prevented.

Though this embodiment refers to an example of a digital television broadcast, similar effects can be obtained even for an analog television broadcast.

The broadcast receiver apparatus in this embodiment will not be limited particularly as long as it can receive a broadcast wave, and it can be a radio receiver as well as a television receiver.

The broadcast receiver apparatus according to the present invention is useful for a portable digital television receiver driven by a battery for example, and the broadcast receiver apparatus is effective for preventing wasteful power consumption caused by an unintended channel search operation. The broadcast receiver apparatus can be applied also to a vehicle television receiver that operates with power from a large size battery.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A broadcast receiver apparatus capable of receiving a broadcast signal and operating with power fed from at least a battery, comprising:
a channel searcher that is capable of an operation of searching for a viewable channel,
a tuner that selects a broadcast wave corresponding to the channel searched by the channel searcher, and
a power remaining amount detector that detects the power remaining amount of the battery;
wherein the broadcast receiver apparatus suppresses the searching operation in accordance with the power remaining amount detected by the power remaining amount detector.

2. The broadcast receiver apparatus according to claim 1, wherein the channel searcher is capable of a whole station search of controlling the tuner and scanning sequentially all of the channels allocated to the broadcast so as to search for a receivable channel, and
suppresses the whole station search when the power remaining amount detected by the power remaining amount detector is less than a value of a first predetermined power remaining amount value.

3. The broadcast receiver apparatus according to claim 1, wherein the channel searcher is capable of a next station search of searching for a receivable adjacent channel with respect to a channel currently selected by the tuner, and
suppresses the next station search when the power remaining amount detected by the power remaining amount detector is less than a value of a second predetermined power remaining amount value.

4. The broadcast receiver apparatus according to claim 1, further comprising an operator capable of selecting and inputting whether or not to perform the channel selection operation by the channel searcher,
the broadcast receiver apparatus suppressing the searching operation when the power remaining amount detected by the power remaining amount detector is less than a predetermined power remaining amount value and when there is an input of selection of not performing the channel selection operation by the operator.

5. The broadcast receiver apparatus according to claim 4, wherein the channel searcher is capable of a whole station search of controlling the tuner and searching sequentially all of the channels allocated to the broadcast so as to search for a receivable channel, and
the broadcast receiver apparatus suppresses the whole station search when the power remaining amount detected by the power remaining amount detector is less than a first predetermined power remaining amount value and when there is an input of selection of not performing the channel selection operation by the operator.

6. The broadcast receiver apparatus according to claim 4, wherein the channel searcher is capable of a next station search of searching for a receivable adjacent channel with respect to a channel currently selected by the tuner, and
the broadcast receiver apparatus suppresses the next station search when the power remaining amount detected by the power remaining amount detector is less than a second predetermined power remaining amount value and there is an input of selection of not performing a channel selection operation by the operator.
